(19) United States
(12) Patent Application Publication
(10) Pub. No.: US 2013/0255690 A1
(43) Pub. Date: Oct. 3, 2013

(54) Method and Device for the Protection of a Resiratory Tract

(71) Applicant: Alexander Luchinskiy, Bad Kreuznach (DE)

(72) Inventor: Alexander Luchinskiy, Bad Kreuznach (DE)

(21) Appl. No.: 13/727,379

(22) Filed: Dec. 26, 2012

Related U.S. Application Data
(60) Provisional application No. 61/581,025, filed on Dec. 28, 2011.

(30) Foreign Application Priority Data
Jun. 10, 2009 (DE) 10 2009 025 060.3
Nov. 7, 2010 (DE) 10 2010 050 298.7

(51) Int. Cl. A62B 23/06

(52) U.S. Cl. CPC A62B 23/06
USPC 128/206.11

(57) ABSTRACT

Method and device are proposed, which provide a long-time efficient protection of a human respiratory tract by means of an invisible from outside intranasal working body. By breath-in the working body acts completely as a filter, and by exhalation it acts completely as a valve. This way the valves can be used in the limited volumes of intranasal cavities without reduction of the useful working volume of a filter. The accumulated during the breath-in phase dust is conducted away to outside again during the exhalation phase. Therewith the necessary filter capacity is reduced to one cycle of breath-in and -out. This way a long-term efficient protection of the respiratory ways is attained. Practically suitable installation way of the said working body in the nostrils is also provided.

### CROSS-REFERENCE TO RELATED APPLICATIONS

This application claims the priority benefits to U.S. provisional patent application Ser. No. 61/581,025 filed Dec. 28, 2011, to German Patent Application DE 10 2009 025 060.3, filed Jun. 10, 2009, to German Patent Application DE 10 2010 050 298.7, filed Nov. 7, 2010.

### STATEMENT REGARDING FEDERALLY SPONSORED RESEARCH OR DEVELOPMENT

Not Applicable

### REFERENCE TO SEQUENCE LISTING; A TABLE; OR A COMPUTER PROGRAM LISTING COMPACT DISC APPENDIX

Not Applicable

### BACKGROUND OF THE INVENTION

(1) Field of the Invention

The present invention relates to methods and devices for protection of a respiratory tract.

(2) Description of Related Art

A method is known for protection of the respiratory tract from the undesirable dust-form solid-body-kind or liquid (droplet-kind) particles in the surrounding air, or in a gas-mixture for the breathing (further is also called as “surrounding air”). The method protects the respiratory tract also from bacteria, viruses and other microorganisms, which are contained in this dust or in these liquid drops, as well from the plant pollen and other particles, which generate allergical reactions. Also a method is known for protection of a respiratory tract from the undesirable gas-form impurities in the air. In all above-mentioned methods the surrounding air is conducted from surrounding through an air-cleaning device (means). The air-cleaning device is normally a filter, or a system of filters, or an absorber as f.e. activated carbon, or a space, which one contains an absorber-substance, or a combination of the above-mentioned elements. Any device (means) for cleaning of the air, independently of the executed way to clean air (independently on the principles of the air cleaning) is named below as a “respirator-working-body”. In all above-mentioned methods the “respirator-working-body” is placed on some distance from the human face, among other possibilities it can hang on a waist belt. After that the cleaned air is further conducted (supplied) through a hose to a mask, and after that this air is supplied to the space between the mask and human face. After that the air from this a.m. space is supplied in the upper respiratory tract through the nostrils and mouth opening. The devices for execution of the a.m. methods are known, which devices contain the a.m. respirator-working-body, the mask, the pipe-line (hose), which one connects the respirator-working-body with the mask, the elements to fix (fasten) the mask on a human face and a valve for the release of the exhalated air (U.S. Pat. No. 4,590,951; U.S. Pat. No. 7,409,952; US 2006/0130834; U.S. Pat. No. 6,182,656).

Besides, a method is known, where the surrounding air is supplied into the space between the mask and human face through the respirator-working-body immediate, i.e. without the pipe-lines. The devices for execution (embodyments) of this method are known, which devices contain the respirator-working-body, which one is connected immediate with the mask, and is fastened (fixed) immediate on the mask. The surrounding air is supplied from the surrounding through the respirator-working-body immediate under the mask. As one of the possibilities can be an usual textile mask, which one consists of a layer of a textile piece, a.o. (among other variants) of a gauze piece, which one covers the lower part of a human face. Besides, this respiratory-protection mask contains the fastening-elements, which fasten (fix) the a.m. piece of textile on a face.

The above-described methods and devices are presented, for example, in the given below patent descriptions: (WO 2009/048748; WO 2008/076472; WO 2008/082700; U.S. Pat. No. 7,237,550; U.S. Pat. No. 7,089,931; US 2005 217669; U.S. Pat. No. 5,558,089; U.S. Pat. No. 4,258,710; DE 9407866; CH 692103).

In all above-mentioned methods and in all a.m. devices the human face is covered by a mask, where the air from the respirator-working-body is supplied firstly into the space between the mask and human face, and only after that the air from this a.m. space is further supplied in the upper respiratory tract.

The disadvantage of the a.m. method and devices is is an essential limitation of their area of application, because the respiratory protection mask is visible on a face, and besides this mask covers and makes invisible at least a part of a face. The respiratory protection masks are used presently only in special situations or in crisis (emergency)-situations, as well as one use the respiratory protection masks during the execution of specifical works, which require the protection of the respiratory tract. According to the usual norms and traditions of social behaviour, it is not usual to carry on a mask in the human community in usual life, also in spite of the essential allergical reactions on pollen or other allergens, and in spite of the danger of contamination by air-drop-infection in a public transport and other public places.

The technical solutions are known for the intranasal air-cleaning devices, i.e. where the air-cleaning devices are placed completely inside the nostrils (as f.e. US 2009/0 020 125 A1; DE 201 01 539 U1; DE 100 23 050 A1, etc.)

All these devices have the following shortcomings:

1) The volume of the filter is too little, because it (volume) is limited by internal dimensions of the nostrils. Therefore the dust-capacity of the filter is too small and, consequently, the time period of an efficient service-life is very short.

2) As it is known, the usual (not intranasal) personal air-cleaning devices (as f.e. gas masks or breathing apparats) contain normally the expiration (breathing-out)-valves. Without these valves it could be difficult to breath. The valves-contained solutions for the intranasal devices also exist (as f.e. US 2009/0 020 125 A1). But an additional installation of a valve reduces even more an useful working volume of the filter, and therefore such constructions are practically not usable.

A more detailed description of the state of technology in the area of intranasal constructions is given below by the examples of the typical technical solutions.

In the US 2009/0 020 125 A1 the case in point is a valve, which one is formed by a big through opening 310 in the respirator-working-body (filter) 100, where this opening 310 has a cover 350 and the devices (means) 330, 340, 360 to provide the reciprocating motion of this cover (FIGS. 5a, 5b). By breathing-in the valve is closed, and therewith the system conducts the breathed-in air through the filter (i.e. through the thickness of the body of the filter). By breathing-out (exhalation) the valve is open, and therewith the system conduct the exhalated air outside the filter (i.e. not through the body of the filter). Therewith here the filter and the valve are two different devices, but both of them are installed in a nostril together. When by breathing-in the filter works, the air does not go through the valve. When an air is exhalated through the valve, the filter does not work.

Such system has the following two disadvantages:
The external surface of the filter, through which surface the air come in the filter, as well as the useful volume of the filter are essentially reduced because of the valve existing (minus surface of the cover; and minus volumes of the opening for the volume of the filter body).
During the exhalation the filter body does not clean itself.

In the DE 100 23 050 A1 the technical subject of the valve-structure is not disclosed and not described. A valve-structure is only mentioned. But it is unambiguously defined in the claim 22, what valve-structure exactly is meaned. And namely: “22. Device according to one of the previous claims, where the filter has a valve-function, which conducts the exhalated air past the filter”.

Therewith both in the DE 100 23 050 A1 and in the a.m. US 2009/0 020 125 A1 the methods and devices are meaned, where the exhalated air is conducted past the filter (i.e. not through the body of the filter). Which constructions (all of them) have the above-mentioned shortcomings (1) and (2).

In the WO 2004/084 998 A1 the technical subject of the case (“Spender”) is not disclosed and not described. A case (“Spender”) for the keeping of the filters is only mentioned. It is also not written about the installation-way of the filters into the nose.

In the U.S. Pat. No. 2,142,276A a container for the storage and for the transporting of the “Nasal filter Mats” is described, which container has not a installing-function and removing-function of the filters (in)/(out from) the nose. One pull out the “Filter Mats” from the container by the “pair of tweezers” (p. 2, lines 30-35).

Besides, this a.m. container is usable only for thouse nose filters, which do not have an element, which one connects two filters intended for two nostrils. (This element is named “joint (connection)” in the present patent application, or “connection portion” 200 FIG. 1-3 in the US 2009/0 020 125 A1 etc.).

### BRIEF SUMMARY OF THE INVENTION

An approach and solution is described, by which a) the volume of the filter does not play a decided role, and b) valve does not reduce the useful time of the filter life.

The following principles are used:

1) As it is known, the gauze mask-respirator has in average 2 hours efficient working time. After this period the gauze mask acts not as a protective mean, but as a source of contamination because of high dust concentration on it.

For a filter inside a nostril this time is maximally several minutes. It also cannot be acceptably increased because it is impossible to increase a nostril volume and consequently the dust capacity of an intranasal filter. As it is impossible to increase the necessary efficient working time up to any practically applicable time period, one could in the opposite, decrease the necessary working time to one breath-in action (several seconds). And then the filter have to clean itself by every exhalation, at least partially. The nasal filter volume is excessively sufficient to “one breath-in time period” efficient work, even if the self-cleaning by every exhalation takes place incompletely.

2) As a valve reduces the useful filter volume on one hand, but it have to be completely placed in the nostril on the other hand, all filter volume have to work as a filter by breathing in and as a valve by breathing out. I.e. the filter structure have to arise anew by every breathing in and have to be disassembled again by every breathing out. During the disassembling process filter have also to clean itself (at least partially-s. above), and some portion of dust particles have to be conducted to outside with a breathed-out air.

This way the working body acts completely as a filter by breathing-in, and as a valve by exhalation. Therefore the valves can be used in the limited volumes of intranasal cavities without reduction of the useful working volume of a filter.

Besides, the more practically applicable principle of installation of the working body in the nostrils is used. This aim is attained through the constructive features of the case for working bodies, which one permits an automatic installation in the true palce quick way. Therewith a long-time and practically applicable protection of the respiratory tract is attained also under the social-surrounding conditions, where one normally cannot use an usual gas mask or an usual breathing-device. Therewith a permanent or long-time protection is attained from the undesirable impurities in the air, among others from the allergens and microorganisms, in all situations, a.o. also in public transport, in all public places, as well as in workstations.

### BRIEF DESCRIPTION OF THE SEVERAL VIEWS OF THE DRAWINGS

The examples of embodiment of the invention are presented in the drawings and is described below.

It is shown:

FIG. 1. Placing of the respirator-working-body in the nostrils. (FIG. 1A—front sectional view; FIG. 1B—side sectional view; FIG. 1C—bottom view);

FIGS. 2 to 8. Schematical representation of the valve-kind elements in the respirator-working-body:

FIG. 2. Hair (strokes)-covered fibers (rods)-structure, state by exhalation (FIG. 2A—front sectional view; FIG. 2B—top sectional view);

FIG. 3. Hairy (strokes)-covered surfaces—structure, state by exhalation (FIG. 3A—front sectional view; FIG. 3B—top sectional view);

FIG. 4. Hairy (strokes)-covered fibers(rods)—structure, state by breathing-in (FIG. 4A—front sectional view; FIG. 4B—top sectional view);

FIG. 5. Hairy (strokes)-covered surfaces—structure, state by breathing-in (FIG. 5A—front sectional view; FIG. 5B—top sectional view);

FIG. 6. Hairy (strokes)-covered spiral roll—structure as an example of an other kind of a hair (strokes)-carried structure of the parallely placed geometrical elements;

FIG. 7. Variant of embodyment (state by breathing-in);

FIG. 8. Variant of embodyment (state by exhalation);

FIGS. 9 to 11. Schematical representation of the method for installing of the respirator-working-bodies in the nostrils and schematical representation of the devices for installation:

FIG. 9. Possible embodyment of the installation device with a piston (FIG. 9A—front sectional view; FIG. 9B—partial view of a stick for the piston displacement in the same front view; FIG. 9C—top sectional view);

FIG. 10. Possible embodyment of the installation device without a piston (FIG. 10A—front sectional view; FIG. 10B—top sectional view; FIG. 10C—axonometric view);

FIG. 11. Possible embodyment of the method for installing of the respirator-working-bodies in the nostrils.

### DETAILED DESCRIPTION OF THE INVENTION

The respirator-working-body 1, which one consists of two parts 2 and 3, is placed in the nostrils 4. Below these parts 2 and 3 of the respiratory-working-body 1 are called shortly as the “RWB-parts”. The RWB-parts are placed completely immediate inside the nostrils, and therefore they are invisible from outside. The RWB-parts 2 and 3 are connected with a connecting body, which one is named below as a “joint (connection)” 5, which one rests (sets) against the nasal septum 6 from below, and therewith prevents a further moving of the a.m. RWB-parts in the upper respiratory tract. Therewith the presented breath-protection method is safe, as well as an easy, quick and suitable removing of the a.m. RWB-parts is attained. As joint (connection) 5 can be used a.o. a thread or a band or any other flexible or rigid (s. below) body. As it is known, the human septum 6 has an anatomical deepening 6a, which deepening is placed exactly on the boundary between the septum and upper lip 6b. Therefore the joint (connection) 5 is fastened on the RWB-parts such way, that the joint (connection) 5 lays exactly in this deepening 6a. Therewith the joint (connection) 5 is practically invisible from outside, also independently from the colour of this joint (connection).

To improve the invisibility of a method, in some variants of the method execution the joint (connection) 5 can be made of a transparent material, or this joint 5 can have the same colour or colour tone as a human skeen. Or this joint 5 can have a colour or colour tones of human hairs, in particular for using by men, who have moustaches.

The surrounding air 7 is conducted immediate in the nose openings (nostrils). The air is conducted through the respirator-working-body 1, where the whole respirator-working-body is placed completely inside the both nostrils 4.

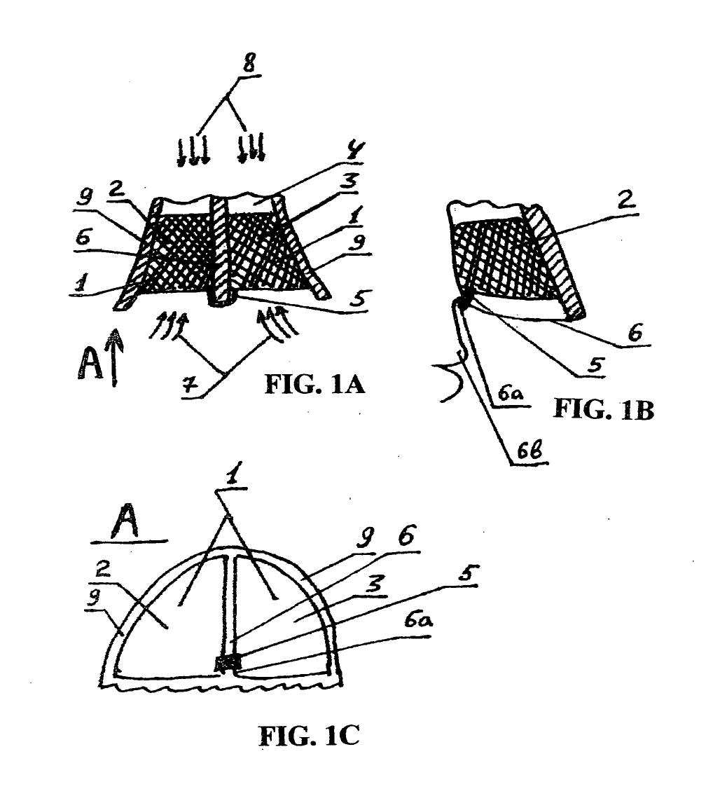

The surrounding air 7 goes through the RWB-parts 2 and 3 of the respirator-working-body 1 into the upper respiratory tract, and the exhalated air 8 from the upper respiratory tract goes in the opposite direction (FIG. 1A-FIG. 1C).

The RWB-parts 2 and 3 are fastened in the nostrils 4 by friction. Nevertheless any other variants of fastening are also possible.

In some embodiment variants the joint 5 is a cramp (clamp), which one embrace from below the nasal septum 6, and this way the RWB-parts are fastened in the nostrils 4.

In one possible embodyment variant the RWB-parts are made of a hydrophob material. It prevents a swelling of the material of the RWB-parts through the condensed water.

Nevertheless the surfaces of the RWB-parts, which surfaces lay in the nostrils immediate near the mucous membrane, can be partially made of the hydrophil material, or these a.m. surfaces can contain one or several such hydrophil areas or points. It makes possible an additional fastening of the RWB-parts in the nostrils.

Nevertheless these fastening methods looks overflowing, because the fastening through friction is sufficient. In any case the RWB-parts 2 and 3 are fastened in the nostrils 4 either on the internal walls of the ala 9 of the nose, or on the nasal septum 6, or both.

In some embodyment variants the respirator-working-body 1 as well as any of their parts 2 and 3 are not homogen, a.o. these RWB-parts contain different layers or zones, also the layers or zones which have different physical properties.

Firstly, similar to the known mask-kind respirators, the RWB-parts can also consist of the different pile-shaped materials of filter, to improve the filtering of the dust-kind impurities. Secondly, the RWB-parts can contain elements, which also clean the surrounding air from the undesirable gas-kind impurities, f.e. absorbers like a.o. activated carbon. The RWB-parts can also contain medicaments, a.o. bakterizid substances, vaso-dilating substances, or substances for making breath more easy, or natural well-being substances as f.e. Garlic, as well as the aromatized substances, as f.e. substances with the lemon smell, which one, as it is known, increase the productivity of human work. The RWB-parts can also contain the capsules for the prolongated long-time supplying of substances. And therewith the above-mentioned additional substances can be placed in these capsules. This way the supplying of a substance in the conducted air can be attained during a long time. The RWB-parts can also contain the chemical heating elements, i.e the substances, which release heat by means of an exothermical chemical reaction. To activate this function one have to press on the RWB-parts or crumple them up. Such way one breaks the capsules with the chemical heating substances. After that these released chemical substances react, as usually, with the air or with other correspondent reaction components, and therewith the heat will be released.

The RWB-parts can also contain the smell-generating indicating substances, which are released by a chemical reaction with definite dangerous substances. Or the smelling substances can be released by a physical displacing from an absorber, when the concentration of harmful substances in the breathed air increases. This way a person can be alarmed about the danger in the true time.

The respirator-working-body 1, which one consists of the RWB-parts 2 and 3, can also have the anizotropical physical properties, dependently on the geometrical direction inside the respirator-working-body.

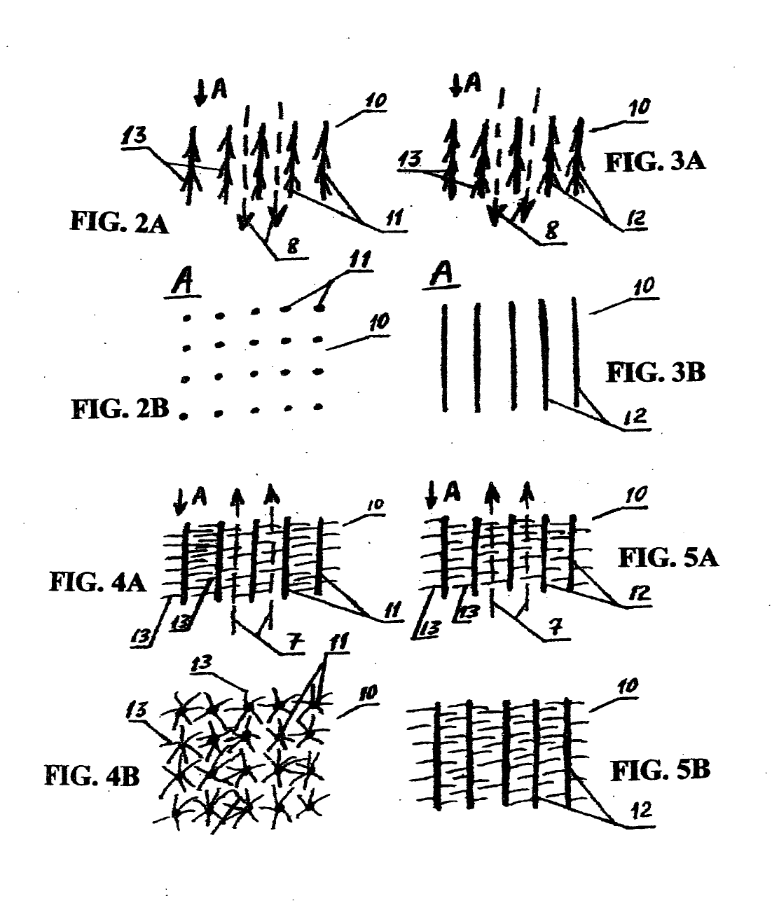

FIG. 2A, FIG. 2B and FIG. 3A, FIG. 3B (state by exhalation) and FIG. 4A, FIG. 4B and FIG. 5A, FIG. 5B (state by breathing-in) represent schematically one example of embodyment of a valve-kind structure inside the RWB-parts 2 and 3. One hairy structure 10 consists of the fibers (rods) 11 (FIG. 2A, FIG. 2B and FIG. 4A, FIG. 4B) or surfaces 12 (FIG. 3A, FIG. 3B and FIG. 5A, FIG. 5B).

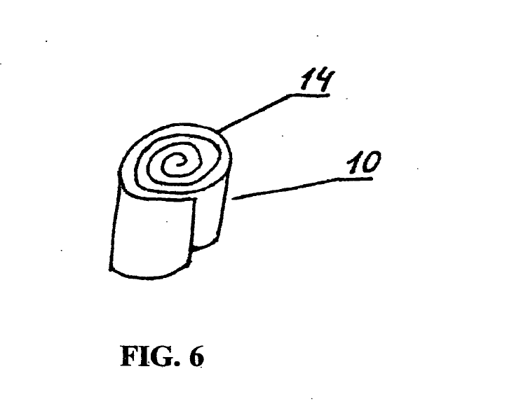

The a.m fibers (rods) or surfaces are covered with hairs (strokes) 13. The Structure 10 is orientated such way, that, by breathing-in, the hairs 13 go up with their free ends to cross one another, and such way these hairs (strokes) 13 form a filter (FIG. 4A, FIG. 4B and FIG. 5A, FIG. 5B). Therewith the breathed-in air 7 is conducted into the upper respiratory tract through such filter. And by exhalation, the free ends of hairs (strokes) sink down again, and therefore the exhalated air 8 is conducted outside without an additional resistance and without filtration (FIG. 2A, FIG. 2B and FIG. 3A, FIG. 3B). Besides, the dust, which one was accumulated on the hairs (strokes) during the breathing-in phase, is again conducted away to outside, completely or partially, during the exhalation (breath-out) phase. And therewith the filter cleans itself by itself. The structure 10 can also consist of any kind of other hair (strokes)-carried parallely placed geometrical elements, for example of spiral rolls 14 (FIG. 6).

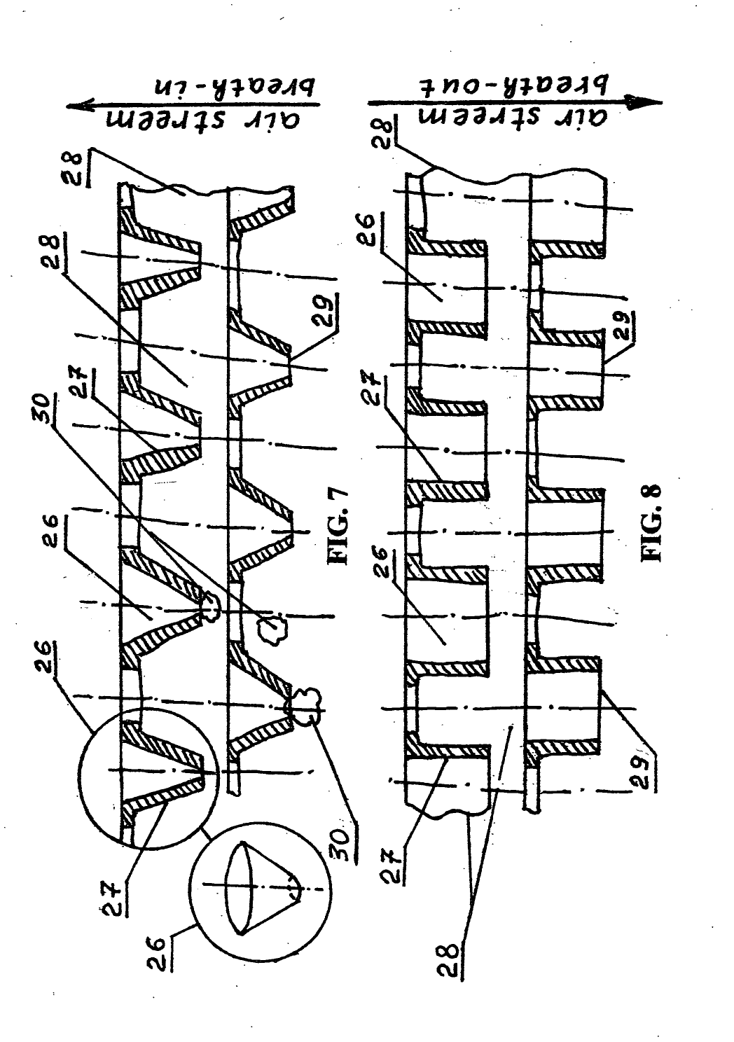

In some variants of embodyment the RWB-parts 2 and 3 of the respirator-working-body 1, or it's separate elements can contain numerous elements 26, cone-shaped, or pyramid-shaped, or in the form of truncated cones or pyramids, or other geometric-shaped elements with the flexible-resilient (or travelling, or both) generatrixes 27, which elements 26 are installed in the respirator-working-body matrix 28 with the possibility to reduce the dimensions of their smaller 29 bases by streeming of the air through these elements in one direction (FIG. 7—state by breath-in), and to increase the a.m. base dimensions by the air streeming through these elements in the opposite direction (FIG. 8—state by exhalation), where the a.m. change of dimensions can be generatable by the air streem by using of the own elasticity of the a.m. elements, or by the streem pressure/streem energy, a.o. by Bemoulli-prinziple, or both (FIG. 7 and FIG. 8). The dust particles 30 are stopped during the breath-in phase and are conducted out to outside during the breath-out phase.

In some variants of embodyment the RWB-parts 2 and 3 of the respirator-working-body 1, or it's separate elements are executed through a nanotechnological process for creation of microsystems, among others, through the LIGA-method. In these embodyments the RWB-parts are the microstructures, or the RWB-parts contain the microstructures. Besides, a.o., the numerous microscopic valves are put together in one system, and after that the summarized air streem from the microvalves-contained system is conducted up in to the upper respiratory tract by breathing-in, and it is conducted down to outside by breathing-out (exhalation). Such way the lower resistence for breath and simultaneously the higher efficiency of the air cleaning is attained.

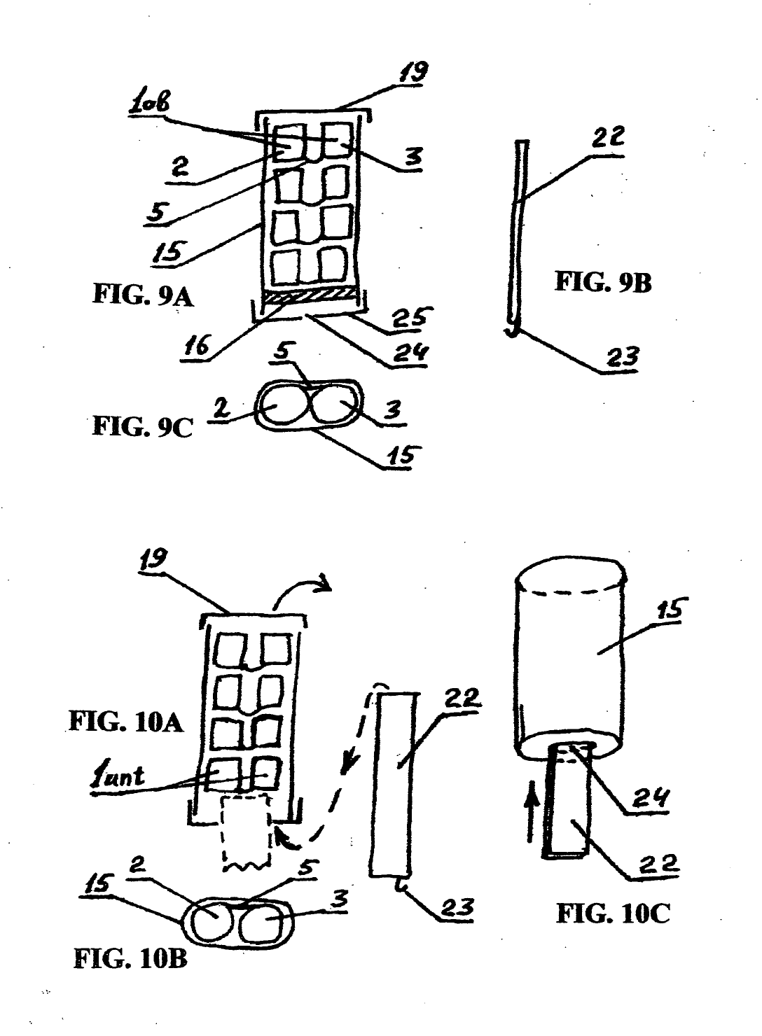

The special means have to be provided for the installation of RWB-parts in the nostrils, because an installing of them by forgers is not suitable and not hygienical. Besides, it is difficult to install the RWB-parts in the nostrils such way, that the joint (connection) 5 could be placed exactly and immediately in the anatomical deepening 6a. Therefore a zylindrical case 15 with the piston 16 is used to install the respirator-working-body in the nostrils (FIG. 9A-FIG. 9C).

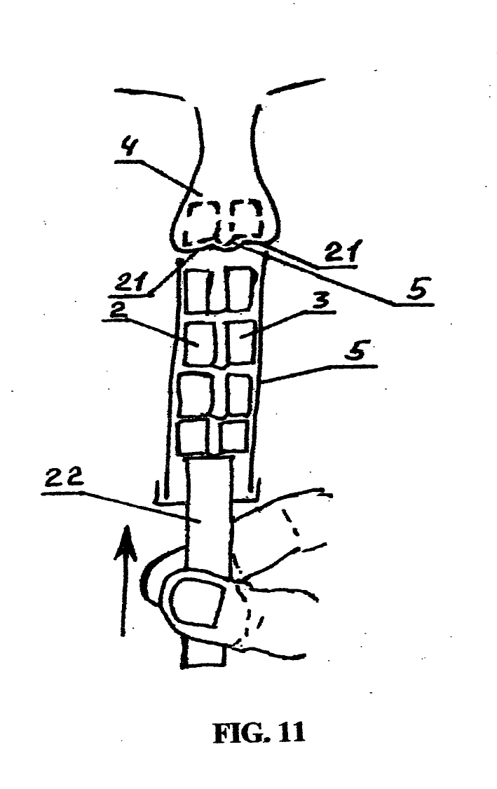

Under the term “zylinder” one understands here it's mathematical meaning, i.e. any body, which one has parallely bases (which one has any kind of geometrical form), and the parallely generating lines). In one variant of embodyment the bases have a form of an oval (FIG. 9A-FIG. 9C, FIG. 10A-FIG. 10C). The respirator-working bodies 1 are placed pile-like (stack-like) one above another in the case 15. Where the left and the right RWB-parts of the each respirator-working-body 1 are placed such way, that the joint (connection) 5 lays between and under the a.m. RWB-parts 2 and 3, and all joints (connections) are placed pile-like (stack-like) one above another along one side (along one generating line of the zylinder) of the case. During the transporting the case 15 is covered from above by a cover 19. To execute the installing of the RWB-parts 2 and 3 in the nostrils 4, one takes off the cover 19, places the upper opening 20 of the case directly under the nostrils 21, press on the piston 16, f.e. by a little stick 22, and therewith one displaces the respirator-working-body 1_{ob}, which one lays above all others in the case 15, from the case 15 in the nostrils 4, up to the position, when the joint (connection) 5 rests from below against the nasal septum 6, and therewith it (joint) prevents the further moving of the RWB-parts 3 and 3 into the upper respiratory tract (FIG. 9A-FIG. 9C, FIG. 10A-FIG. 10C, FIG. 11).

In one example of embodyments the case 15 does not contain a piston 16, and one displaces up the pile of the respirator-working-bodies by the little stick directly. In this case the little stick 22 is made in the form of a spatula or in the form of a flat plate rod (FIG. 10A-FIG. 10C, FIG. 11). Therewith one press from below on the both parts 2 and 3 of the lower in the pile respirator-working-body 1ᵤₙₜ by the little stick 22 through the opening 24 in the case cover 25.

For the removing of the respirator-working-body from the nostrils the RWB-parts 2 and 3 are removed by pulling of joint (connection) 5 by a hook 23 or by fingers, where a.o. the a.m. hook 23 is fastened, removable or not removable, on the cas 15. The little stick 22 can be also fastened, removable or not removable, on the case 15, as well the little stick 22 and the hook 23 can be made as a one body.

For the situations, when one have to breath under the essential physical load or when the nasal respiratory ways are blocked, completely or partially because of illness, one can use an other part 18 of the respiratory-working-body 1, which one called below as a “mouth-RWB-part”. In this case the respirator-working-body 1 can consist of three parts; two of them are the RWB-parts 2 and 3, and the third part, i.e. the mouth-RWB-part is placed in the mouth cavity, and it is characterised by the same physical features, as the a.m. RWB-parts. Among other variants, the mouth-RWB-part can contain the all a.m. zones or elements. In one embodyment variant the mouth-RWB-part can be executed in the form of a plate, which plate can be fastened in the mouth between the lips and teeth. With the aim to reduce a visibility, the mouth-RWB-part a.o. also can be placed behind the teeth, and besides also a.o. it can be fastened by the hooks or brackets on some teeth.

Thus, the proposed method and device provide a long-time efficient protection of a human respiratory tract by means of an invisible from outside intranasal working body. By breath-in the working body acts completely as a filter, and by exhalation it acts completely as a valve. This way the valves can be used in the limited volumes of intranatal cavities without reduction of the useful working volume of a filter.

The accumulated during the breath-in phase dust is conducted away to outside again during the exhalation phase. Therewith the necessary filter capacity is reduced to one cycle of breath-in and -out. This way a long-term efficient protection of the respiratory ways is attained. Practically suitable method and device for the installation of the said working body in the nostrils and for removing of the said working body from the nostrils is also provided.

What is claimed is:

1. Method for the protection of a respiratory tract, where a surrounding air is conducted (directed) through a respirator-working-body, and after that this air is conducted into the respiratory tract, where the surrounding air goes directly in the nose openings (in the nostrils), after that the air is further streeming through the placed in the nasal cavities respirator-working-body, where the whole respirator-working-body is placed completely in the both nasal cavities, and where the respirator-working-body consists of the two parts (below they are named as “RWB-parts”), which RWB-parts are fixed on the internal walls of the sides of the nose, or on the nasal septum, or both, and besides, among other ways of fixing, the both above mentioned RWB-parts are connected with a joint (connection), which one rests (sets) against the nasal septum from below, and therewith prevents a further moving of the a.m. RWB-parts in the upper respiratory tract, and after that the air further streems in the upper respiratory tract,
where in the each inspiration (breath-in) phase a filter is newly formed (created) by the air, which one goes up in the respiratory tract, and therewith the breathed-in air is further conducted into the upper respiratory tract through this filter; and in the each exhalation phase this filter inside the respirator-working-body is disassembled again, and therewith the exhalated (breathed-out) air is conducted away (to outside) through the respiratory-working-body without additional resistance and filtration, where a dust, which one was accumulated in the filter during the breath-in phase, is again conducted away (to outside), completely or partially, during the exhalation (breath-out) phase, and therewith the respirator-working-body cleans itself by itself.

2. Method according to claim 1, where the inspirated (breathed in) air is conducted along the numerous, equel-kind (uniform), placed parallely one near another, hairs (strokes)-carried geometric elements, which geometric elements can be, among other variants, surfaces or fibers (Fasem), where the a.m. geometric elements, a.o. surfaces or fibers, are covered by hairs (strokes), and where the whole above mentioned structure of elements is orientated such way, that when inspiring (breathing in), the hairs (strokes), which cover the near one to another located different surfaces (or fibers), go up with their free ends to cross one another, set (adjust) semselves perpendicularly to the a.m. surfaces (or fibers), and therewith form (create) a filter, after that the inspired (breathed in) air is conducted through this filter into the upper respiratory tract; and when exhalating (breathing out), the hairs (strokes) sink down again, and therewith they make the way for the air free again, and therewith the exhalated (breathed out) air is conducted away to outside without resistence and filtration,
where the dust, which one was accumulated on the hairs (strokes) during the inspiration (breathing-in)-phase, is conducted away to outside again, completely or partially, during the exhalation (breathing-out)-phase.

3. Method according to claim 1, where the inspirated (breathed in) air is conducted through the numerous elements, which elements change their form or position in the space or both dependently on the direction of the streeming through them air, where by the streeming of an air in one direction (breath-in phase) the a.m. elements change their form such way, that the not contained any elements surface for a free air streeming is redused, and by the streeming of the air in the opposite direction (exhalation phase) the not contained any elements surface for a free air streeming is increased, where the size of the holes, (which holes are forming the a.m. free surface), is less then the diameter of the separate dust particles for the a.m. element form and positions in the breath-in phase, but this size is bigger then the diameter of the separate dust particles for the a.m. element form and positions in the exhalation phase

4. Method according to claim 1, where the process according to claim 1 is realised (executed, embodied) in a micro-system, where the surrounding air on claim 1 streems through a respirator-working-body on claim 1, where the respirator-working-body-parts (RWB-parts) on claim 1 or the constraction elements of the respiratory-working-body are produced (executed, made) through a nanotechnological process of technological production of microsystems, among others through the LIGA-process.

5. Method according to claim 2, where the process according to claim 2 is realised (executed, embodied) in a micro-system, where the surrounding air streems through a respirator-working-body, where the RWB-parts or the constraction elements of the respiratory-working-body are produced (executed, made) through a nanotechnological process of technological production of microsystems, among others through the LIGA-process.

6. Method according to claim 3, where the process according to claim 3 is realised (executed, embodied) in a micro-system, where the surrounding air streems through a respirator-working-body, where the RWB-parts or the constraction elements of the respiratory-working-body are produced (executed, made) through a nanotechnological process of technological production of microsystems, among others through the LIGA-process.

7. Method of installation of the respirator-working-body parts (RWB-parts) in the nasal cavities, where one places horizontally the both RWB-parts, where the joints (connections) lay between the a.m. RWB-parts, after that one places the different a.m. respirator-working-bodies pile-like (stack-like) one above another, besides one places these respirator-working-bodies in a cylindrical, vertically orientated case, which case have two openings, the first one of them is in the upper end of the case, and the second one of them is in the lower part of the case, after that one places the upper opening of the case directly under the nostrils openings, and after that one press by one or several pistons from below through the lower opening of the case, and therewith one displaces (moves) the respirator-working body, which one lays in the upper position in the case, from the case into the nostrils, up to the position, when the joint (connection) on claim 1 rests from below against the nasal septum, and therewith it (joint) prevents the further moving of the RWB-parts into the upper respiratory tract.

8. Method according to claim 7, where the RWB-parts are removed through pulling of the joint (connection) by a hook, where, the a.m. hook can, among other variants, be fastened, removably or not removably, on the case on claim 7.

9. Device for the protection of a respiratory tract, in particular for execution of the method according to claims 1, containing a respirator-working-body (RWB), which one consists of two parts (RWB-parts), which RWB-parts are completely located in the nasal cavities (in the nostrils), the RWB-parts can be (but not must be) connected on to another by a joint (connection), which one rests (sets) against the nasal septum from below, and therewith prevents a further moving of the a.m. RWB-parts in the upper respiratory tract, the RWB-parts are fixed on the internal walls of the sides of the nose, or on the nasal septum, or both, where a substance of the each RWB-part is executed such way that by an air streeming through this RWB-part in one directing, the RWB-part acts as a filter, and by the air streeming through the same RWB-part in the opposite direction, this RWB-part acts as a valve, i.e it does not filters the streeming air and does not resists to it's streeming, where each RWB-part is placed (orientated) in the nasal cavity such way, that by air streeming up (i.e. in the breathing-in phase) the RWB-part acts as a filter, and by the air streeming down (i.e. in the exhalation phase) the RWB-part acts as a valve, and besides, the dust, accumulated by the formed (built) in the breath-in phase filter, can be exhousted to outside again during the exhalation phase because of the diss-forming (diss-building) of the a.m. filter.

10. Device according to claim 9, containing numerous, equel-kind (uniform), placed parallely one near another, hairs (strokes)-carried geometric elements, which geometric elements can be executed, among other variants, as surfaces or fibers (Fasem), where the a.m. geometric elements, a.o. surfaces or fibers, are covered by hairs (strokes), and where the whole above mentioned structure of elements is orientated such way, that in the inspiring (breathing in)-phase, the hairs(strokes), which cover the near one to another located different surfaces (or fibers), can go up with their free ends to cross one another, set (adjust) semselves perpendicularly to the a.m. surfaces (or fibers), and therewith form (create) a filter, so that the inspired (breathed in) air can be conducted through this filter into the upper respiratory tract; and in the exhalation (breathing out)-phase, the hairs (strokes) can sink down again, and therewith they can make the way for the air free again, and therewith the exhalated (breathed out) air can be conducted away to outside without resistence and filtration, where, in the filter-working-mode, the device contains a dust, which one was accumulated on the hairs (strokes) during the inspiration (breathing-in)-phase, and in the end of the next, valve-working-mode, the device does not contain a dust (or contains less dust), which dust is conducted away to outside again, completely or partially, during the exhalation (breathing-out)-phase.

11. Device according to claim 9, containing numerous elements, cone-shaped, or pyramid-shaped, or in the form of truncated cones or pyramids, or other geometric-shaped elements with the flexible-resilient (or travelling, or both) generatrixes, which elements are installed in the respirator-working-body matrix with the possibility to change (i.e. either to reduce or to increase) the dimensions of their smaller (or larger or both) bases by streeming of the air through these elements in one direction, and to change again vice-versa (i.e. either to increase or to reduce correspondently) the a.m. base dimensions by the air streeming through these elements in the opposite direction, where the a.m. change of dimensions can be generatable by the air streem by using of the own elasticity of the a.m. elements, or by the streem pressure/streem energy, a.o. by Bernoulli-prinziple, or both.

12. Device according to claim 9, where the RWB-parts are the microstructures, or the RWB-parts contain the microstructures, where the RWB-parts or their separate elements are executed through a nanotechnological process for creation of microsystems, among others, through the LIGA-method, and besides, a.o., the numerous microscopic valves are put together in one system (in one matrix).

13. Device according to claim 9, containing at least one or several of the following means:
means for cleaning the surrounding air from the undesirable gas-kind impurities, f.e. absorbers like a.o. activated carbon.
medicaments, a.o. bakterizid substances, vaso-dilating substances, or substances for making breath more easy, or natural well-being substances as f.e. Garlic, as well as the aromatized substances, as f.e. substances with the lemon smell, which one, as it is known, increase the productivity of human work.
capsules for the prolongated long-time supplying of substances, where the above-mentioned additional substances are placed in these capsules.
chemical heating elements, i.e the substances, which release heat by means of an exothermical chemical reaction.
smell-generating indicating substances, which are released by a chemical reaction with definite dangerous substances, or the smelling substances can be released by a physical displacing from an absorber, when the concentration of harmful substances in the breathed air increases, wherewith a person can be alarmed about the danger in the true time.

14. Device according to claim 10, containing at least one or several of the following means:
means for cleaning the surrounding air from the undesirable gas-kind impurities, f.e. absorbers like a.o. activated carbon.
medicaments, a.o. bakterizid substances, vaso-dilating substances, or substances for making breath more easy, or natural well-being substances as f.e. Garlic, as well as the aromatized substances, as f.e. substances with the lemon smell, which one, as it is known, increase the productivity of human work.
capsules for the prolongated long-time supplying of substances, where the above-mentioned additional substances are placed in these capsules.
chemical heating elements, i.e the substances, which release heat by means of an exothermical chemical reaction.
smell-generating indicating substances, which are released by a chemical reaction with definite dangerous substances, or the smelling substances can be released by a physical displacing from an absorber, when the concentration of harmful substances in the breathed air increases, wherewith a person can be alarmed about the danger in the true time.

15. Device according to claim 11, containing at least one or several of the following means:
means for cleaning the surrounding air from the undesirable gas-kind impurities, f.e. absorbers like a.o. activated carbon.
medicaments, a.o. bakterizid substances, vaso-dilating substances, or substances for making breath more easy, or natural well-being substances as f.e. Garlic, as well as the aromatized substances, as f.e. substances with the lemon smell, which one, as it is known, increase the productivity of human work.
capsules for the prolongated long-time supplying of substances, where the above-mentioned additional substances are placed in these capsules.
chemical heating elements, i.e the substances, which release heat by means of an exothermical chemical reaction.
smell-generating indicating substances, which are released by a chemical reaction with definite dangerous substances, or the smelling substances can be released by a physical displacing from an absorber, when the concentration of harmful substances in the breathed air increases, wherewith a person can be alarmed about the danger in the true time.

16. Device according to claim 12, containing at least one or several of the following means:
means for cleaning the surrounding air from the undesirable gas-kind impurities, f.e. absorbers like a.o. activated carbon.
medicaments, a.o. bakterizid substances, vaso-dilating substances, or substances for making breath more easy, or natural well-being substances as f.e. Garlic, as well as the aromatized substances, as f.e. substances with the lemon smell, which one, as it is known, increase the productivity of human work.
capsules for the prolongated long-time supplying of substances, where the above-mentioned additional substances are placed in these capsules.
chemical heating elements, i.e the substances, which release heat by means of an exothermical chemical reaction.
smell-generating indicating substances, which are released by a chemical reaction with definite dangerous substances, or the smelling substances can be released by a physical displacing from an absorber, when the concentration of harmful substances in the breathed air increases, wherewith a person can be alarmed about the danger in the true time.

17. Device according to claim 9, where the respirator-working-body consists of three parts; two of them are the RWB-parts, which are located in the nasal cavities, and the third part, i.e. the mouth-RWB-part is placed in the mouth cavity, and it is characterised by the same physical features, as the RWB-parts.

18. Device according to claim 17, where mouth-RWB-part is a microstructure, or the mouth-RWB-part contains the microstructures, where the mouth-RWB-part or it's separate elements are executed through a nanotechnological process for creation of microsystems, among others, through the LIGA-method, and besides, a.o., the numerous microscopic valves are put together in one system (in one matrix).

19. Device according to claim 17, containing at least one or several of the following means:
means for cleaning the surrounding air from the undesirable gas-kind impurities, f.e. absorbers like a.o. activated carbon.
medicaments, a.o. bakterizid substances, vaso-dilating substances, or substances for making breath more easy, or natural well-being substances as f.e. Garlic, as well as the aromatized substances, as f.e. substances with the lemon smell, which one, as it is known, increase the productivity of human work.
capsules for the prolongated long-time supplying of substances, where the above-mentioned additional substances are placed in these capsules.
chemical heating elements, i.e the substances, which release heat by means of an exothermical chemical reaction.
smell-generating indicating substances, which are released by a chemical reaction with definite dangerous substances, or the smelling substances can be released by a physical displacing from an absorber, when the concentration of harmful substances in the breathed air increases, wherewith a person can be alarmed about the danger in the true time.

20. Device according to claim 18, containing at least one or several of the following means:
means for cleaning the surrounding air from the undesirable gas-kind impurities, f.e. absorbers like a.o. activated carbon.
medicaments, a.o. bakterizid substances, vaso-dilating substances, or substances for making breath more easy, or natural well-being substances as f.e. Garlic, as well as the aromatized substances, as f.e. substances with the lemon smell, which one, as it is known, increase the productivity of human work.
capsules for the prolongated long-time supplying of substances, where the above-mentioned additional substances are placed in these capsules.
chemical heating elements, i.e the substances, which release heat by means of an exothermical chemical reaction.
smell-generating indicating substances, which are released by a chemical reaction with definite dangerous substances, or the smelling substances can be released by a physical displacing from an absorber, when the concentration of harmful substances in the breathed air increases, wherewith a person can be alarmed about the danger in the true time.
